(19) United States
(12) Patent Application Publication
(10) Pub. No.: US 2026/0129241 A1
(43) Pub. Date: May 7, 2026

(54) METHOD FOR DECODING IMAGE INFORMATION, METHOD FOR ENCODING IMAGE INFORMATION, AND METHOD FOR TRANSMITTING DATA FOR IMAGE INFORMATION

(71) Applicant: LG Electronics Inc., Seoul (KR)

(72) Inventors: Hendry TAN, Seoul (KR); Junghak NAM, Seoul (KR); Jaehyun LIM, Seoul (KR); Seunghwan KIM, Seoul (KR)

(21) Appl. No.: 19/440,087

(22) Filed: Jan. 5, 2026

Related U.S. Application Data
(63) Continuation of application No. PCT/KR2025/004732, filed on Apr. 8, 2025.
(60) Provisional application No. 63/631,497, filed on Apr. 9, 2024.
(60) Provisional application No. 63/636,893, filed on Apr. 22, 2024.

(51) Int. Cl. H04N 19/70

(52) U.S. Cl. CPC H04N 19/70

(57) ABSTRACT

According to an embodiment of the present disclosure, a method for decoding image information includes obtaining the image information including supplemental enhancement information (SEI) messages, a SEI processing order message indicating a processing order for a group of types of the SEI messages, and a processing order nesting message including at least one nested SEI message in a processing chain specified by the SEI processing order message, and deriving the processing order of the SEI messages based on the SEI processing order message. The SEI processing order message includes wrapping flag information indicating whether a SEI message in a processing chain specified by the SEI processing order message is included in the processing order nesting message.

### CROSS-REFERENCE TO RELATED APPLICATIONS

This application is a Bypass Continuation Application of International Application No. PCT/KR2025/004732, filed on Apr. 8, 2025, which claims priority from U.S. Provisional Application No. 63/631,497, filed on Apr. 9, 2024, and U.S. Provisional Application No. 63/636,893, filed on Apr. 22, 2024, the disclosures of which are incorporated by reference in their entireties.

### BACKGROUND

### 1. Field

The present disclosure relates to a method of decoding image information, a method of encoding image information, and/or a method of transmitting a bitstream of image information.

### 2. Description of the Related Art

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### SUMMARY

Therefore, it is an aspect of the present disclosure to provide an encoding/decoding method and/or apparatus with improved coding efficiency.

It is another aspect of the present disclosure to give flexibility to supplemental enhancement information (SEI) messages.

It is another aspect of the present disclosure to provide an encoding/decoding method and/or apparatus of which coding efficiency and coding rates are improved due to the flexibility of SEI messages.

Technical objects to be achieved in the present disclosure are not limited to those described above, and other technical objects that have not been described above will be clearly understood by those skilled in the technical field to which the present disclosure pertains from the following description.

According to an embodiment of the present disclosure, a method for decoding image information includes obtaining the image information including supplemental enhancement information (SEI) messages, a SEI processing order message indicating a processing order for a group of types of the SEI messages, and a processing order nesting message including at least one nested SEI message in a processing chain specified by the SEI processing order message, and deriving the processing order of the SEI messages based on the SEI processing order message. The SEI processing order message includes wrapping flag information indicating whether a SEI message in a processing chain specified by the SEI processing order message is included in the processing order nesting message.

According to an embodiment of the present disclosure, an apparatus for decoding information includes a memory and at least one processor coupled to the memory. The at least one processor is configured to obtain the image information including supplemental enhancement information (SEI) messages, a SEI processing order message indicating a processing order for a group of types of the SEI messages, and a processing order nesting message including at least one nested SEI message in a processing chain specified by the SEI processing order message, and derive the processing order of the SEI messages based on the SEI processing order message. The SEI processing order message includes wrapping flag information indicating whether a SEI message in a processing chain specified by the SEI processing order message is included in the processing order nesting message.

According to the embodiment of the present disclosure, in the method or the apparatus for decoding image information, based on a value of the wrapping flag information equal to 1, the SEI message in a processing chain specified by the SEI processing order message may be included in the processing order nesting message, and based on the value of the wrapping flag information equal to 0, the SEI message in a processing chain specified by the SEI processing order message may not be included in the processing order nesting message.

According to the embodiment of the present disclosure, in the method or the apparatus for decoding image information, based on a value of the wrapping flag information equal to 1, a target identifier of the processing order nesting message is equal to an identifier of the SEI processing order message, a payload type of the at least one nested SEI message may be equal to a payload type specified by the SEI processing order message and a processing order of the at least one nested SEI message may be equal to a processing order specified by the SEI processing order message.

According to the embodiment of the present disclosure, in the method or the apparatus for decoding image information, the SEI message in the processing chain specified by the SEI processing order message being not presence in the image information may be allowed.

According to the embodiment of the present disclosure, in the method or the apparatus for decoding image information, the SEI message in the processing chain specified by the SEI processing order message may include at least one of a SEI message being presence in the image information or a SEI message being not presence in the image information.

According to the embodiment of the present disclosure, in the method or the apparatus for decoding image information, the SEI processing order message may include payload type information indicating a payload type of a SEI message, and the payload type information may include at least one of type information of a SEI message being presence in the image information or type information of a SEI message being not presence in the image information.

According to the embodiment of the present disclosure, in the method or the apparatus for decoding image information, based on a value of the wrapping flag information equal to 1 and the SEI message in a processing chain specified by the SEI processing order message being presence in the image information, the SEI message in a processing chain specified by the SEI processing order message may be included in the processing order nesting message, and based on the value of the wrapping flag information equal to 0 and the SEI message in a processing chain specified by the SEI processing order message being presence in the image information, the SEI message in a processing chain specified by the SEI processing order message may not be included in the processing order nesting message.

According to an embodiment of the present disclosure, a method for encoding image information includes generating supplemental enhancement information (SEI) messages; determining a processing order for a group of types of the SEI messages; generating a SEI processing order message indicating the processing order based on the processing order; generating a processing order nesting message including at least one nested SEI message in a processing chain specified by the SEI processing order message; and encoding the image information including the SEI processing order message and the processing order nesting message. The SEI processing order message includes wrapping flag information indicating whether a SEI message in a processing chain specified by the SEI processing order message is included in the processing order nesting message.

According to an embodiment of the present disclosure, an apparatus for decoding information includes a memory and at least one processor coupled to the memory. The at least one processor is configured to generate supplemental enhancement information (SEI) messages; determine a processing order for a group of types of the SEI messages; generate a SEI processing order message indicating the processing order based on the processing order; generate a processing order nesting message including at least one nested SEI message in a processing chain specified by the SEI processing order message; and encode the image information including the SEI processing order message and the processing order nesting message. The SEI processing order message includes wrapping flag information indicating whether a SEI message in a processing chain specified by the SEI processing order message is included in the processing order nesting message.

According to the embodiment of the present disclosure, in the method or the apparatus for encoding image information, based on a value of the wrapping flag information equal to 1, the SEI message in a processing chain specified by the SEI processing order message may be included in the processing order nesting message, and based on the value of the wrapping flag information equal to 0, the SEI message in a processing chain specified by the SEI processing order message may not be included in the processing order nesting message.

According to the embodiment of the present disclosure, in the method or the apparatus for encoding image information, based on a value of the wrapping flag information equal to 1, a target identifier of the processing order nesting message is equal to an identifier of the SEI processing order message, a payload type of the at least one nested SEI message may be equal to a payload type specified by the SEI processing order message and a processing order of the at least one nested SEI message may be equal to a processing order specified by the SEI processing order message.

According to the embodiment of the present disclosure, in the method or the apparatus for encoding image information, the SEI message in the processing chain specified by the SEI processing order message being not presence in the image information may be allowed.

According to the embodiment of the present disclosure, in the method or the apparatus for encoding image information, the SEI message in the processing chain specified by the SEI processing order message may include at least one of a SEI message being presence in the image information or a SEI message being not presence in the image information.

According to the embodiment of the present disclosure, in the method or the apparatus for decoding image information, the SEI processing order message may include payload type information indicating a payload type of a SEI message, and the payload type information may include at least one of type information of a SEI message being presence in the image information or type information of a SEI message being not presence in the image information.

According to the embodiment of the present disclosure, in the method or the apparatus for encoding image information, based on a value of the wrapping flag information equal to 1 and the SEI message in a processing chain specified by the SEI processing order message being presence in the image information, the SEI message in a processing chain specified by the SEI processing order message may be included in the processing order nesting message, and based on the value of the wrapping flag information equal to 0 and the SEI message in a processing chain specified by the SEI processing order message being presence in the image information, the SEI message in a processing chain specified by the SEI processing order message may not be included in the processing order nesting message.

According to an embodiment of the present disclosure, a method for transmitting data for image information includes generating a bitstream for the image information, and transmitting the data comprising the bitstream. The bitstream is generated based on generating supplemental enhancement information (SEI) messages, determining a processing order for a group of types of the SEI messages, generating a SEI processing order message indicating the processing order based on the processing order, generating a processing order nesting message including at least one nested SEI message in a processing chain specified by the SEI processing order message, and generating the bitstream for the image information including the SEI processing order message and the processing order nesting message. The SEI processing order message includes wrapping flag information indicating whether a SEI message in a processing chain specified by the SEI processing order message is included in the processing order nesting message.

According to an embodiment of the present disclosure, an apparatus for transmitting data for image information includes at least one processor configured to generate a bitstream for the image information, and a transmitter configured to transmit the data comprising the bitstream. The bitstream is generated based on generating supplemental enhancement information (SEI) messages, determining a processing order for a group of types of the SEI messages, generating a SEI processing order message indicating the processing order based on the processing order, generating a processing order nesting message including at least one nested SEI message in a processing chain specified by the SEI processing order message, and generating the bitstream for the image information including the SEI processing order message and the processing order nesting message. The SEI processing order message includes wrapping flag information indicating whether a SEI message in a processing chain specified by the SEI processing order message is included in the processing order nesting message.

According to an embodiment of the present disclosure, a computer-readable recording medium stores a bitstream for the image information. The bitstream is generated based on generating supplemental enhancement information (SEI) messages, determining a processing order for a group of types of the SEI messages, generating a SEI processing order message indicating the processing order based on the processing order, generating a processing order nesting message including at least one nested SEI message in a processing chain specified by the SEI processing order message, and generating the bitstream for the image information including the SEI processing order message and the processing order nesting message. The SEI processing order message includes wrapping flag information indicating whether a SEI message in a processing chain specified by the SEI processing order message is included in the processing order nesting message.

The features of the present disclosure briefly summarized above are merely illustrative aspects of the detailed description of the present disclosure and do not limit the scope of the present disclosure.

According to the present disclosure, an encoding/decoding method and/or apparatus with improved coding efficiency can be provided.

According to the present disclosure, flexibility can be given to SEI messages.

According to the present disclosure, it is possible to provide an encoding/decoding method and/or apparatus of which coding efficiency and coding rates are improved due to the flexibility of SEI messages.

Effects of the present disclosure are not limited to those described above, and other effects that have not been described above will be clearly understood by those skilled in the technical field to which the present disclosure pertains from the following description.

### BRIEF DESCRIPTION OF DRAWINGS

FIG. 1 is a view schematically showing a video coding system to which an embodiment of the present disclosure is applicable.

FIG. 2 is a diagram schematically illustrating an image encoding device to which an embodiment according to the present disclosure can be applied.

FIG. 3 is a schematic diagram illustrating an image decoding device to which an embodiment according to the present disclosure can be applied.

FIG. 4 exemplarily shows a hierarchical structure for coded video/image to which an embodiment according to the present disclosure can be applied.

FIG. 5 is a flowchart illustrating a method of decoding image information according to an embodiment of the present disclosure;

FIG. 6 is a flowchart illustrating a method of encoding image information according to an embodiment of the present disclosure;

FIG. 7 is a diagram exemplifying a content streaming system to which an embodiment according to the present disclosure can be applied.

### DETAILED DESCRIPTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

The present disclosure presents various embodiments of video/image coding, and unless otherwise stated, the embodiments may be performed in combination with each other.

The terms used in the present disclosure may have their usual meanings in the technical field to which the present disclosure belongs, unless newly defined in the present disclosure.

In the present disclosure, a “picture” generally means a unit representing one image of a specific time period, and a slice/tile is a coding unit constituting a part of a picture, and one picture may be composed of one or more slices/tiles. In addition, a slice/tile may include one or more CTUs (coding tree units). One picture may be composed of one or more tile groups. One tile group may include one or more tiles. A brick may represent a rectangular area of CTU rows of tiles in a picture. In this document, tile group and slice may be used interchangeably. For example, in this document, a tile group/tile group header may be called a slice/slice header.

In the present disclosure, a “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. One unit may include one luma block and two chroma (e.g., Cb, Cr) blocks. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The chroma component block of the current block may be expressed by including an explicit description of a chroma component block such as “chroma block” or “current chroma block.

In the present disclosure, the term “/” and “,” should be interpreted to indicate “and/or”. For instance, the expression “A/B” and “A, B” may mean “A and/or B.” Further, “A/B/C” and “A, B, C” may mean “at least one of A, B, and/or C.”

In the present disclosure, the term “or” should be interpreted to indicate “and/or.” For instance, the expression “A or B” may comprise 1) only “A”, 2) only “B”, and/or 3) both “A and B”. In other words, in the present disclosure, the term “or” should be interpreted to indicate “additionally or alternatively.”

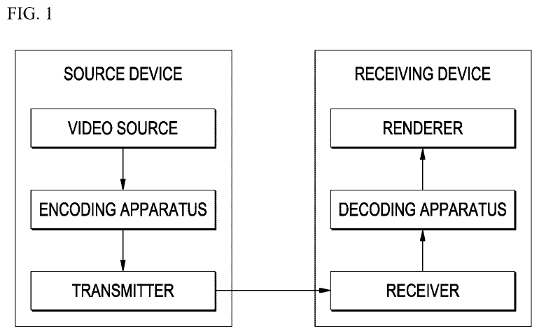

FIG. 1 is a view schematically showing a video coding system to which an embodiment of the present disclosure is applicable.

The video coding system according to an embodiment may include an encoding device 10 and a decoding device 20. The encoding device 10 may deliver encoded video and/or image information or data to the decoding device 20 in the form of a file or streaming via a digital storage medium or network.

The encoding device 10 according to an embodiment may include a video source generator 11, an encoder 12 and a transmitter 13. The decoding device 20 according to an embodiment may include a receiver 21, a decoder 22 and a renderer 23. The encoder 12 may be called a video/image encoding apparatus, and the decoder 22 may be called a video/image decoding apparatus. The transmitter 13 may be included in the encoder 12. The receiver 21 may be included in the decoder 22. The renderer 23 may include a display and the display may be configured as a separate device or an external component.

The video source generator 11 may obtain a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoder 12 may encode an input video/image. The encoder 12 may perform a series of procedures such as prediction, transform, and quantization for compression and coding efficiency. The encoder 12 may output encoded data (encoded video/image information) in the form of a bitstream.

The transmitter 13 may transmit the encoded video/image information or data output in the form of a bitstream to the receiver 21 of the decoding device 20 through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream and transmit the bitstream to the decoder 22.

The decoder 22 may decode the video/image by performing a series of procedures such as dequantization, inverse transform, and prediction corresponding to the operation of the encoder 12.

The renderer 23 may render the decoded video/image. The rendered video/image may be displayed through the display.

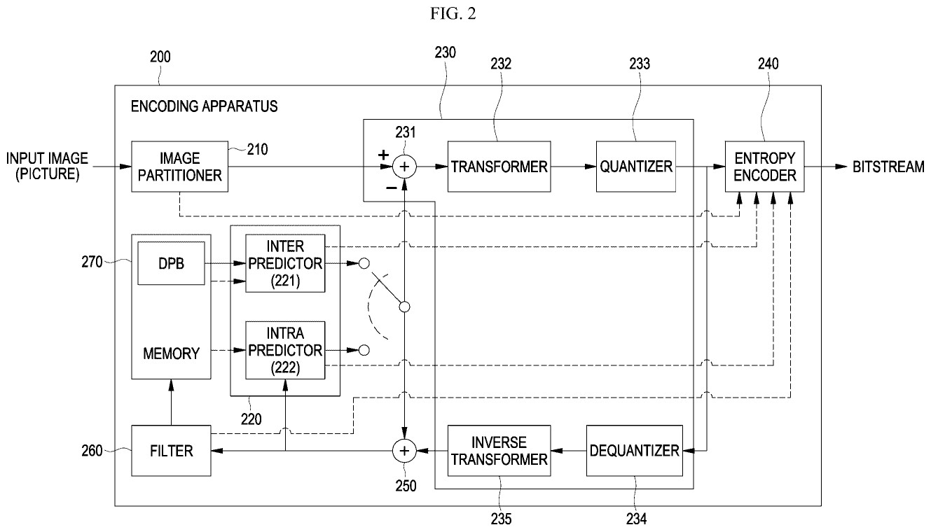

FIG. 2 is a diagram schematically illustrating an image encoding device to which an embodiment according to the present disclosure can be applied.

Referring to FIG. 2, the encoding apparatus 200 includes an image partitioner 210, a predictor 220, a residual processor 230, and an entropy encoder 240, an adder 250, a filter 260, and a memory 270. The predictor 220 may include an inter predictor 221 and an intra predictor 222. The residual processor 230 may include a transformer 232, a quantizer 233, a dequantizer 234, and an inverse transformer 235. The residual processor 230 may further include a subtractor 231. The adder 250 may be called a reconstructor or a reconstructed block generator. The image partitioner 210, the predictor 220, the residual processor 230, the entropy encoder 240, the adder 250, and the filter 260 may be configured by at least one hardware component (ex. an encoder chipset or processor) according to an embodiment. In addition, the memory 270 may include a decoded picture buffer (DPB) or may be configured by a digital storage medium. The hardware component may further include the memory 270 as an internal/external component.

The image partitioner 210 may partition an input image (or a picture or a frame) input to the encoding apparatus 200 into one or more processors. For example, the processor may be called a coding unit (CU). In this case, the coding unit may be recursively partitioned according to a quad-tree binary-tree ternary-tree (QTBTTT) structure from a coding tree unit (CTU) or a largest coding unit (LCU). For example, one coding unit may be partitioned into a plurality of coding units of a deeper depth based on a quad tree structure, a binary tree structure, and/or a ternary structure. In this case, for example, the quad tree structure may be applied first and the binary tree structure and/or ternary structure may be applied later. Alternatively, the binary tree structure may be applied first. The coding procedure according to this document may be performed based on the final coding unit that is no longer partitioned. In this case, the largest coding unit may be used as the final coding unit based on coding efficiency according to image characteristics, or if necessary, the coding unit may be recursively partitioned into coding units of deeper depth and a coding unit having an optimal size may be used as the final coding unit. Here, the coding procedure may include a procedure of prediction, transform, and reconstruction, which will be described later. As another example, the processor may further include a prediction unit (PU) or a transform unit (TU). In this case, the prediction unit and the transform unit may be split or partitioned from the aforementioned final coding unit. The prediction unit may be a unit of sample prediction, and the transform unit may be a unit for deriving a transform coefficient and/or a unit for deriving a residual signal from the transform coefficient.

The term unit may be used interchangeably with terms such as block or area, depending on the case. In general, an M×N block can represent a set of samples or transform coefficients consisting of M columns and N rows. A sample can generally represent a pixel or a pixel value, and may represent only a pixel/pixel value of a luma component, or only a pixel/pixel value of a chroma component. A sample can be used as a term corresponding to a pixel or pel in a picture (or image).

In the encoding apparatus 200, a prediction signal (predicted block, prediction sample array) output from the inter predictor 221 or the intra predictor 222 is subtracted from an input image signal (original block, original sample array) to generate a residual signal residual block, residual sample array), and the generated residual signal is transmitted to the transformer 232. In this case, as shown, a unit for subtracting a prediction signal (predicted block, prediction sample array) from the input image signal (original block, original sample array) in the encoder 200 may be called a subtractor 231. The predictor may perform prediction on a block to be processed (hereinafter, referred to as a current block) and generate a predicted block including prediction samples for the current block. The predictor may determine whether intra prediction or inter prediction is applied on a current block or CU basis. As described later in the description of each prediction mode, the predictor may generate various information related to prediction, such as prediction mode information, and transmit the generated information to the entropy encoder 240. The information on the prediction may be encoded in the entropy encoder 240 and output in the form of a bitstream.

The intra predictor 222 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 222 may determine the prediction mode applied to the current block by using a prediction mode applied to a neighboring block.

The inter predictor 221 may derive a predicted block for the current block based on a reference block (reference sample array) specified by a motion vector on a reference picture. Here, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like, and the reference picture including the temporal neighboring block may be called a collocated picture (colPic). For example, the inter predictor 221 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 221 may use motion information of the neighboring block as motion information of the current block. In the skip mode, unlike the merge mode, the residual signal may not be transmitted. In the case of the motion vector prediction (MVP) mode, the motion vector of the neighboring block may be used as a motion vector predictor and the motion vector of the current block may be indicated by signaling a motion vector difference.

The predictor 220 may generate a prediction signal based on various prediction methods described below. For example, the predictor may not only apply intra prediction or inter prediction to predict one block but also simultaneously apply both intra prediction and inter prediction. This may be called combined inter and intra prediction (CIIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in this document. The palette mode may be considered as an example of intra coding or intra prediction. When the palette mode is applied, a sample value within a picture may be signaled based on information on the palette table and the palette index.

The prediction signal generated by the predictor (including the inter predictor 221 and/or the intra predictor 222) may be used to generate a reconstructed signal or to generate a residual signal. The subtraction unit 115 can subtract the prediction signal (predicted block, predicted sample array) output from the prediction unit 200 from the input image signal (original block, original sample array) to generate a residual signal (residual block, residual sample array). The generated residual signal can be transmitted to the conversion unit 232.

The transformer 232 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform generated based on a prediction signal generated using all previously reconstructed pixels. In addition, the transform process may be applied to square pixel blocks having the same size or may be applied to blocks having a variable size rather than square.

The quantizer 233 may quantize the transform coefficients and transmit them to the entropy encoder 240 and the entropy encoder 240 may encode the quantized signal (information on the quantized transform coefficients) and output a bitstream. The information on the quantized transform coefficients may be referred to as residual information. The quantizer 233 may rearrange block type quantized transform coefficients into a one-dimensional vector form based on a coefficient scanning order and generate information on the quantized transform coefficients based on the quantized transform coefficients in the one-dimensional vector form. Information on transform coefficients may be generated.

The entropy encoder 240 may perform various encoding methods such as, for example, exponential Golomb, context-adaptive variable length coding (CAVLC), context-adaptive binary arithmetic coding (CABAC), and the like. The entropy encoder 240 may encode information necessary for video/image reconstruction other than quantized transform coefficients (ex. values of syntax elements, etc.) together or separately. Encoded information (ex. encoded video/image information) may be transmitted or stored in units of NALs (network abstraction layer) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. In this document, information and/or syntax elements transmitted/signaled from the encoding apparatus to the decoding apparatus may be included in video/picture information. The video/image information may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 240 and/or a storage unit (not shown) storing the signal may be included as internal/external element of the encoding apparatus 200, and alternatively, the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transformer 235.

Meanwhile, LMCS (luma mapping with chroma scaling) may be applied during the picture encoding and/or restoration process.

The adder 250 adds the reconstructed residual signal to the prediction signal output from the inter predictor 221 or the intra predictor 222 to generate a reconstructed signal (reconstructed picture, reconstructed block, reconstructed sample array). If there is no residual for the block to be processed, such as a case where the skip mode is applied, the predicted block may be used as the reconstructed block. The adder 250 may be called a reconstructor or a reconstructed block generator. The generated reconstructed signal may be used for intra prediction of a next block to be processed in the current picture and may be used for inter prediction of a next picture through filtering as described below.

The filter 260 may improve subjective/objective image quality by applying filtering to the reconstructed signal. For example, the filter 260 may generate a modified reconstructed picture by applying various filtering methods to the reconstructed picture and store the modified reconstructed picture in the memory 270, specifically, a DPB of the memory 270. The various filtering methods may include, for example, deblocking filtering, a sample adaptive offset, an adaptive loop filter, a bilateral filter, and the like. The filter 260 may generate various information related to the filtering and transmit the generated information to the entropy encoder 240 as described later in the description of each filtering method. The information related to the filtering may be encoded by the entropy encoder 240 and output in the form of a bitstream.

The modified reconstructed picture transmitted to the memory 270 may be used as the reference picture in the inter predictor 221. When the inter prediction is applied through the encoding apparatus, prediction mismatch between the encoding apparatus 200 and the decoding apparatus may be avoided and encoding efficiency may be improved.

The DPB of the memory 270 may store the modified reconstructed picture for use as a reference picture in the inter predictor 221. The memory 270 may store the motion information of the block from which the motion information in the current picture is derived (or encoded) and/or the motion information of the blocks in the picture that have already been reconstructed. The stored motion information may be transmitted to the inter predictor 221 and used as the motion information of the spatial neighboring block or the motion information of the temporal neighboring block. The memory 270 may store reconstructed samples of reconstructed blocks in the current picture and may transfer the reconstructed samples to the intra predictor 222.

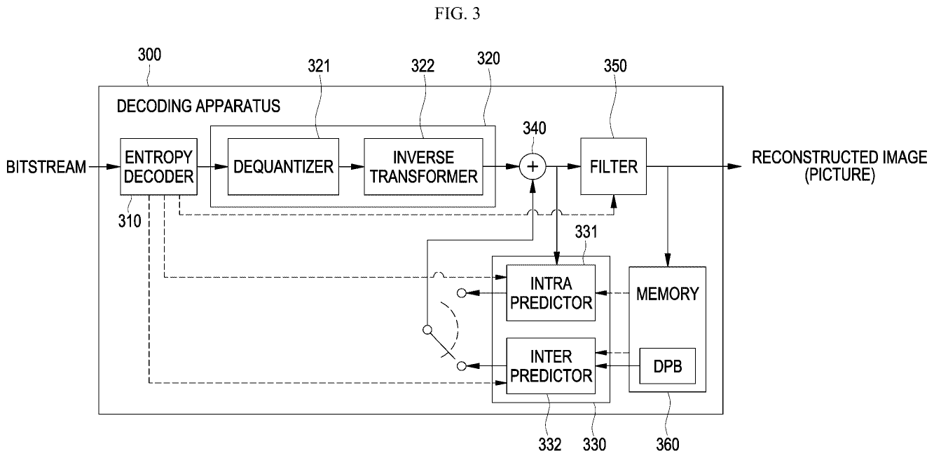

FIG. 3 is a schematic diagram illustrating an image decoding device to which an embodiment according to the present disclosure can be applied.

Referring to FIG. 3, the decoding apparatus 300 may include an entropy decoder 310, a residual processor 320, a predictor 330, an adder 340, a filter 350, a memory 360. The predictor 330 may include an inter predictor 331 and an intra predictor 332. The residual processor 320 may include a dequantizer 321 and an inverse transformer 321. The entropy decoder 310, the residual processor 320, the predictor 330, the adder 340, and the filter 350 may be configured by a hardware component (ex. a decoder chipset or a processor) according to an embodiment. In addition, the memory 360 may include a decoded picture buffer (DPB) or may be configured by a digital storage medium. The hardware component may further include the memory 360 as an internal/external component.

When a bitstream including video/image information is input, the decoding apparatus 300 may reconstruct an image corresponding to a process in which the video/image information is processed in the encoding apparatus of FIG. 2. For example, the decoding apparatus 300 may derive units/blocks based on block partition related information obtained from the bitstream. The decoding apparatus 300 may perform decoding using a processor applied in the encoding apparatus. Thus, the processor of decoding may be a coding unit, for example, and the coding unit may be partitioned according to a quad tree structure, binary tree structure and/or ternary tree structure from the coding tree unit or the largest coding unit. One or more transform units may be derived from the coding unit. The reconstructed image signal decoded and output through the decoding apparatus 300 may be reproduced through a reproducing apparatus.

The decoding apparatus 300 may receive a signal output from the encoding apparatus of FIG. 2 in the form of a bitstream, and the received signal may be decoded through the entropy decoder 310. For example, the entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The decoding apparatus may further decode picture based on the information on the parameter set and/or the general constraint information. Signaled/received information and/or syntax elements described later in this document may be decoded may decode the decoding procedure and obtained from the bitstream. For example, the entropy decoder 310 decodes the information in the bitstream based on a coding method such as exponential Golomb coding, CAVLC, or CABAC, and output syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a decoding target block or information of a symbol/bin decoded in a previous stage, and perform an arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 310 may be provided to the predictor (the inter predictor 332 and the intra predictor 331), and the residual value on which the entropy decoding was performed in the entropy decoder 310, that is, the quantized transform coefficients and related parameter information, may be input to the residual processor 320. The residual processor 320 may derive the residual signal (the residual block, the residual samples, the residual sample array). In addition, information on filtering among information decoded by the entropy decoder 310 may be provided to the filter 350. Meanwhile, a receiver (not shown) for receiving a signal output from the encoding apparatus may be further configured as an internal/external element of the decoding apparatus 300, or the receiver may be a component of the entropy decoder 310. Meanwhile, the decoding apparatus according to this document may be referred to as a video/image/picture decoding apparatus, and the decoding apparatus may be classified into an information decoder (video/image/picture information decoder) and a sample decoder (video/image/picture sample decoder). The information decoder may include the entropy decoder 310, and the sample decoder may include at least one of the dequantizer 321, the inverse transformer 322, the adder 340, the filter 350, the memory 360, the inter predictor 332, and the intra predictor 331.

The dequantizer 321 may dequantize the quantized transform coefficients and output the transform coefficients. The dequantizer 321 may rearrange the quantized transform coefficients in the form of a two-dimensional block form. In this case, the rearrangement may be performed based on the coefficient scanning order performed in the encoding apparatus. The dequantizer 321 may perform dequantization on the quantized transform coefficients by using a quantization parameter (ex. quantization step size information) and obtain transform coefficients.

The inverse transformer 322 inversely transforms the transform coefficients to obtain a residual signal (residual block, residual sample array).

The predictor 330 may generate a prediction signal based on various prediction methods described below. For example, the predictor may apply intra prediction or inter prediction for prediction of one block, and may also apply intra prediction and inter prediction at the same time. This may be called combined inter and intra prediction (CIIP). In addition, the predictor may be based on an intra block copy (IBC) prediction mode or a palette mode for prediction of a block. The IBC prediction mode or palette mode may be used for content image/video coding such as games, such as screen content coding (SCC). The IBC basically performs prediction within the current picture, but may be performed similarly to inter prediction in that it derives a reference block within the current picture. That is, the IBC may use at least one of the inter prediction techniques described in this document. The palette mode may be viewed as an example of intra coding or intra prediction. When palette mode is applied, information about the palette table and palette index may be signaled and included in the video/image information.

The intra predictor 332 may predict the current block by referring to the samples in the current picture. The referenced samples may be located in the neighborhood of the current block or may be located apart according to the prediction mode. In intra prediction, prediction modes may include a plurality of non-directional modes and a plurality of directional modes. The intra predictor 331 may determine the prediction mode applied to the current block by using the prediction mode applied to the neighboring block.

The inter predictor 331 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 332 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 340 may generate a reconstructed signal (reconstructed picture, reconstructed block, reconstructed sample array) by adding the obtained residual signal to the prediction signal (predicted block, predicted sample array) output from the predictor (including the inter predictor 332 and/or the intra predictor 331). If there is no residual for the block to be processed, such as when the skip mode is applied, the predicted block may be used as the reconstructed block. The adder 340 may be called reconstructor or a reconstructed block generator. The generated reconstructed signal may be used for intra prediction of a next block to be processed in the current picture, may be output through filtering as described below, or may be used for inter prediction of a next picture.

Meanwhile, LMCS (luma mapping with chroma scaling) may be applied during the picture decoding process.

The filter 350 may improve subjective/objective image quality by applying filtering to the reconstructed signal. For example, the filter 350 may generate a modified reconstructed picture by applying various filtering methods to the reconstructed picture and store the modified reconstructed picture in the memory 360, specifically, a DPB of the memory 360. The various filtering methods may include, for example, deblocking filtering, a sample adaptive offset, an adaptive loop filter, a bilateral filter, and the like.

The (modified) reconstructed picture stored in the DPB of the memory 360 may be used as a reference picture in the inter predictor 332. The memory 360 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 360 may store reconstructed samples of reconstructed blocks in the current picture and transfer the reconstructed samples to the intra predictor 331.

In the present disclosure, the embodiments described in the filter 260, the inter predictor 221, and the intra predictor 222 of the encoding apparatus 100 may be the same as or respectively applied to correspond to the filter 350, the inter predictor 332, and the intra predictor 331 of the decoding apparatus 300. The same may also apply to the unit 332 and the intra predictor 331.

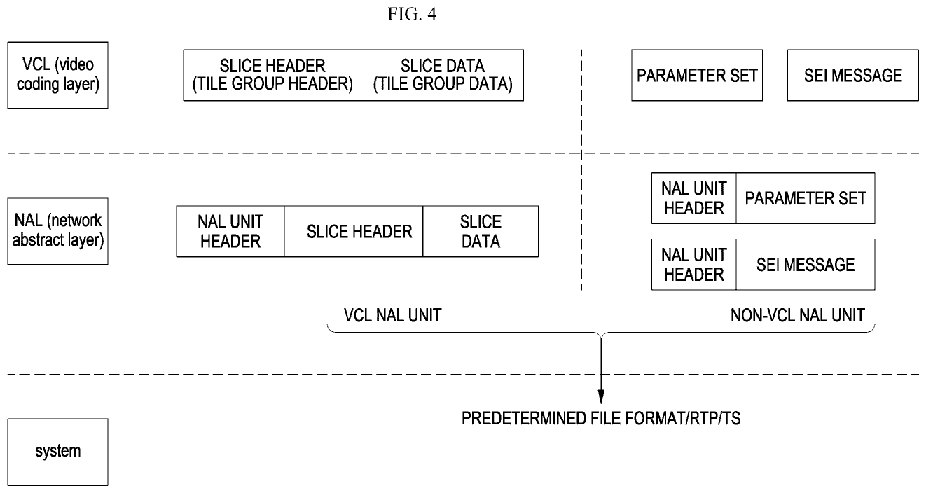

FIG. 4 exemplarily shows a hierarchical structure for coded video/image to which an embodiment according to the present disclosure can be applied.

Referring to FIG. 4, coded image/video is divided into a VCL (video coding layer) that handles the decoding process of the image/video and itself, a subsystem that transmits and stores the coded information, and NAL (network abstraction layer) in charge of function and present between the VCL and the subsystem.

In the VCL, VCL data including compressed image data (slice data) is generated, or a parameter set including a picture parameter set (PSP), a sequence parameter set (SPS), and a video parameter set (VPS) or a supplemental enhancement information (SEI) message additionally required for an image decoding process may be generated.

In the NAL, a NAL unit may be generated by adding header information (NAL unit header) to a raw byte sequence payload (RBSP) generated in a VCL. In this case, the RBSP refers to slice data, parameter set, SEI message, etc., generated in the VCL. The NAL unit header may include NAL unit type information specified according to RBSP data included in the corresponding NAL unit.

As shown in the figure, the NAL unit may be classified into a VCL NAL unit and a Non-VCL NAL unit according to the RBSP generated in the VCL. The VCL NAL unit may mean a NAL unit that includes information on the image (slice data) on the image, and the Non-VCL NAL unit may mean a NAL unit that includes information (parameter set or SEI message) required for decoding the image.

The above-described VCL NAL unit and Non-VCL NAL unit may be transmitted through a network by attaching header information according to the data standard of the subsystem. For example, the NAL unit may be transformed into a data format of a predetermined standard such as an H.266/VVC file format, a real-time transport protocol (RTP), a transport stream (TS), etc., and transmitted through various networks.

As described above, the NAL unit may be specified with the NAL unit type according to the RBSP data structure included in the corresponding NAL unit, and information on the NAL unit type may be stored and signaled in the NAL unit header.

For example, the NAL unit may be classified into a VCL NAL unit type and a Non-VCL NAL unit type according to whether the NAL unit includes information (slice data) about an image. The VCL NAL unit type may be classified according to the nature and type of pictures included in the VCL NAL unit, and the Non-VCL NAL unit type may be classified according to types of parameter sets.

The following is an example of the NAL unit type specified according to the type of parameter set included in the Non-VCL NAL unit type.

APS (Adaptation Parameter Set) NAL unit: Type for NAL unit including APS

DPS (Decoding Parameter Set) NAL unit: Type for NAL unit including DPS

VPS (Video Parameter Set) NAL unit: Type for NAL unit including VPS

SPS (Sequence Parameter Set) NAL unit: Type for NAL unit including SPS PPS (Picture Parameter Set) NAL unit: Type for NAL unit including PPS

The aforementioned NAL unit types may have syntax information for the NAL unit type, and the syntax information may be stored and signaled in a NAL unit header. For example, the syntax information may be nal_unit_type, and NAL unit types may be specified by a nal_unit_type value.

The slice header (slice header syntax) may include information/parameters that may be commonly applied to the slice. The APS (APS syntax) or the PPS (PPS syntax) may include information/parameters that may be commonly applied to one or more slices or pictures. The SPS (SPS syntax) may include information/parameters that may be commonly applied to one or more sequences. The VPS (VPS syntax) may include information/parameters that may be commonly applied to multiple layers. The DPS (DPS syntax) may include information/parameters that may be commonly applied to the overall video. The DPS may include information/parameters related to concatenation of a coded video sequence (CVS). High level syntax (HLS) in this document may include at least one of the APS syntax, PPS syntax, SPS syntax, VPS syntax, DPS syntax, a picture header syntax and slice header syntax.

In this document, the image/video information encoded from the encoding apparatus and signaled to the decoding apparatus in the form of a bitstream includes not only partitioning related information in a picture, intra/inter prediction information, residual information, in-loop filtering information, etc., but also information included in a slice header, information included in the picture header, information included in the APS, information included in the PPS, information included in an SPS, information included in a VPS and/or information included in a DPS.

The SEI message related to the present invention is described.

Table 1 shows an example of the SEI processing order SEI message syntax.

TABLE 1

| | Descriptor |
|---|---|
| sei_processing_order( payloadSize ) { | |
| po_id | u(8) |
| po_num_sei_messages_minus2 | u(8) |
| for( i = 0, i < po_num_sei_messages_minus2 + 2; i++ ) { | |
| po_sei_wrapping_flag[ i ] | u(1) |
| po_sei_importance_flag[ i ] | u(1) |
| po_sei_payload_type[ i ] | u(13) |
| po_sei_prefix_flag[ i ] | u(1) |
| po_sei_processing_order[i] | u(8) |
| } | |
| for( i = 0; i < po_num_sei_messages_minus2 + 2; i++ ) | |
| if( po_sei_prefix_flag[ i ] ) { | |
| po_num_bits_in_prefix_indication_minus1[ i ] | u(8) |
| for( j = 0; j <= po_num_bits_in_prefix_indication_minus1[ i ]; j++ ) | |
| po_sei_prefix_data_bit[ i ][ j ] | u(1) |
| while( !byte_aligned( ) ) | |
| po_byte_alignment_bit_equal_to_one /* equal to 1 */ | f(1) |
| } | |
| } | |

The SEI processing order (SPO) SEI message carries information indicating the preferred processing order, as determined by the encoder (i.e., the content producer), for a group of types of SEI messages that may be present in a CVS.

The semantics of the SPO SEI message uses the concept of types of SEI messages. SEI messages that have different payloadType values are considered different types of SEI messages. Additionally, different SEI messages that have the same payloadType value but are differentiated by values of syntax elements in the SEI payload are considered different types of SEI messages. Such differentiation by values of syntax elements in the SEI payload is to be performed by comparing values sent using po_sei_prefix_data_bit[i][j] syntax elements (when present) or values sent as SEI messages within a processing order nesting SEI message (when present). For example, neural-network post-filter characteristics (NNPFC) SEI messages can be differentiated by having different nnpfc_id values.

When the i-th SEI message seiA in any SPO SEI message has po_sei_wrapping_flag[i] and po_sei_prefix_flag[i] both equal to 0, there shall be no other SEI message seiB included in the same SPO SEI message or in a different SPO SEI message in the current CVS for which all of the following are true:

The value of po_sei_payload_type[i] of seiB is the same as that for seiA.

The value of po_sei_wrapping_flag[i] of seiB is equal to 0.

The value of po_sei_prefix_flag[i] of seiB is equal to 1.

When an SPO SEI message with a particular value of po_id is present in any access unit of a CVS, an SPO SEI message with that particular value of po_id shall be present in the first access unit of the CVS in decoding order. The number of SEI messages and the payloadType codes of the SEI messages indicated within each SPO SEI message with the same value of po_id persist in decoding order from the current access unit until the end of the CVS in output order.

The SPO SEI message can carry one or more SEI prefix indications of a particular payloadType. When present, each SEI prefix indication is a bit string that follows the SEI payload syntax of that value of payloadType and contains a number of complete syntax elements starting from the first syntax element in the SEI payload. These SEI prefix indications should provide sufficient information to determine the specific processing order for types of SEI messages having the same value of payloadType but a different preferred processing order.

The po_id contains an identifying number to identify the SPO SEI message.

A processing chain consists of a list of types of SEI messages identified by an SPO SEI message in the preferred processing order indicated in the SPO SEI message.

Each type of SEI message in the processing chain indicated by an SPO SEI message is identified by the syntax elements po_sei_payload_type[i], po_sei_wrapping_flag[i], po_sei_processing_order[i] and, when present, po_num_bits_in_prefix_indication_minus1[i] and po_prefix_data_bit[i][j].

An SEI message type is not required to belong to any processing chain and may belong to any number of processing chains identified by SPO SEI messages with different po_id values.

Each SEI message of an SEI message type identified within the SPO SEI message has the same persistence scope as if the SEI message was carried outside of the SPO SEI message and not identified within an SPO SEI message.

Processing chains can be alternatives to each other, i.e., such that at most processing chain is chosen to be applied, or they can be complementary, i.e., such that more than one processing chain is chosen and applied separately, with each processing chain generating one output.

The po_num_sei_messages_minus2 plus 2 indicates the number of types of SEI messages for which the preferred order of processing is indicated in the SPO SEI message.

The po_sei_wrapping_flag[i] equal to 1 specifies that one or more processing order nesting SEI messages with both of the following constraints should be present:

The pon_target_po_id[j] with any value of j is equal to po_id.

There is a k-th loop entry in the processing order nesting SEI message such that the payloadType of the k-th nested SEI message is equal to po_sei_payload_type[i] and pon_processing_order[k] is equal to po_sei_processing_order[i].

When po_sei_wrapping_flag[i] is equal to 0, an SEI message with payloadType equal to po_sei_payload_type[i] (and, when po_sei_prefix_flag[i] equal to 1, prefix data that matches the values of po_sei_prefix_data_bit[i][j]) should be present outside of the processing order nesting SEI message.

The po_sei_wrapping_flag[i] equal to 1 enables SEI messages to be carried within the processing order nesting SEI message to prevent such SEI messages from being incorrectly interpreted by decoders that do not process the SPO SEI message. Thus, po_sei_wrapping_flag[i] equal to 1 is intended to be used when po_sei_wrapping_flag[i] equal to 0 can lead to unintended results being produced by such decoders.

The po_sei_importance_flag[i] indicates the degree of importance determined by the encoder for the type of SEI message with index i.

If the decoding system cannot interpret or does not support the functionality indicated by any indicated SEI message that has po_sei_importance_flag[i] equal to 1, it should ignore the entire SPO SEI message.

The po_sei_payload_type[i] specifies the payloadType value of the i-th type of SEI message.

The po_sei_prefix_flag[i] equal to 1 specifies that po_num_bits_in_prefix_indication_minus1[i] and some po_sei_prefix_data_bit[i][j] syntax elements are present. po_sei_prefix_flag[i] equal to 0 specifies that these syntax elements are not present.

SeiProcessingOrderSeiList is set to consist of the payloadType values 3, 4, 5, 19, 137, 142, 144, 147, 148, 149, 165, 177, 210, and 211. The value of po_sei_payload_type[i] for each i in the range of 0 to po_num_sei_messages_minus2+1, inclusive, shall be equal to a value in SeiProcessingOrderSeiList.

The po_sei_processing_order[i] indicates the preferred order of processing of the i-th type of SEI message for which preferred processing order information is provided in the SPO SEI message. For any two different integer values of m and n, po_sei_processing_order[m] less than po_sei_processing_order[n] indicates that the type of SEI message associated with index m should be processed before the type of SEI message associated with index n, and po_sei_processing_order[m] equal to po_sei_processing_order[n] indicates that there is no preferred order of processing between the types of SEI messages associated with indexes m and n (e.g., they can indicate different properties that are both applicable at that stage, or alternative processes that can be applied, or one can indicate a property and the other can indicate a process).

For i greater than 0, po_sei_processing_order[i] shall be greater than or equal to po_sei_processing_order[i−1].

The po_num_bits_in_prefix_indication_minus1[i] and po_sei_prefix_data_bit[i][j], when present, have the same semantics as the num_bits_in_prefix_indication_minus1[i] and sei_prefix_data_bit[i][j] syntax elements of the SEI prefix indication SEI message, with prefix_sei_payload_type replaced by po_sei_payload_type[i].

When more than one SPO SEI message with a particular value of po_id is present in a CVS, the values of po_num_sei_messages_minus2 and, for each value of i, the values of po_sei_wrapping_flag[i], po_sei_prefix_flag[i], po_sei_importance_flag[i], po_sei_payload_type[i], po_sei_processing_order[i] shall be the same as in the other SPO SEI messages in the CVS with the same value of po_id.

The po_byte_alignment_bit_equal_to_one shall be equal to 1.

Table 2 shows an example of the processing order nested SEI message syntax.

TABLE 2

| | Descriptor |
|---|---|
| processing_order_nesting( payloadSize ) { | |
| pon_num_po_ids_minus1 | u(8) |
| for( i = 0; i <= pon_num_po_ids_minus1; i++ ) | |
| pon_target_po_id[ i ] | u(8) |
| pon_num_seis_minus1 | u(8) |
| for( i = 0; i <= pon_num_seis_minus1; i++ ) { | |
| pon_processing_order[ i ] | u(8) |
| sei_message( ) | |
| } | |
| } | |

The processing order nesting (PON) SEI message includes one or more SEI messages that should be applied only as parts of the processing chain identified by an associated SEI processing order SEI message and should not be applied in a manner that would contradict with the processing chain identified by the associated SEI processing order SEI message.

The SEI messages contained in a PON SEI message are referred to as PON-nested SEI messages.

NOTE—An encoder can include multiple PON SEI messages in the same access unit. For example, a first PON SEI message in an access unit can contain a PON-nested SEI message that applies to multiple processing chains and one or more other PON SEI messages in the same access unit that apply to a single processing chain only.

It is a requirement of bitstream conformance that the semantics and effect of an SEI message that is not a PON-nested SEI message shall not depend on any PON-nested SEI message. Consequences of this constraint include the following specific constraints, in which an associated SEI message is considered to be an SEI message that affects the semantics or effect of a particular SEI message:

When a neural-network post-filter characteristics SEI message is present with a particular value of nnpfc_id that is a PON-nested SEI message, any associated neural-network post-filter activation SEI messages with nnpfa_target_id equal to that particular value of nnpfc_id shall also be PON-nested SEI messages.

When a neural-network post-filter activation (NNPFA) SEI message is present with nnpfa_persistence_flag equal to 1 and a particular value of nnpfa_target_id that is not a PON-nested SEI message, the next picture in output order in the same CLVS that has an NNPFA SEI message with the same value of nnpfa_target_id (if any) shall not have an associated NNPFA SEI message that is a PON-nested SEI message.

When a film grain characteristics SEI message is present with fg_characteristics_persistence_flag equal to 1 that is not a PON-nested SEI message, there shall not be an associated film grain characteristics SEI message in the same CLVS that is a PON-nested SEI message.

When a frame packing arrangement SEI message is present with fp_arrangement_persistence_flag equal to 1 that is not a PON-nested SEI message, there shall not be an associated frame packing arrangement SEI message in the same CLVS with fp_arrangement_cancel_flag equal to 1 or the same value of fp_arrangement_id that is a PON-nested SEI message.

When a content colour volume SEI message is present with ccv_persistence_flag equal to 1 that is not a PON-nested SEI message, there shall not be an associated frame packing arrangement SEI message in the same CLVS that is a PON-nested SEI message.

When an equirectangular projection SEI message is present with erp_persistence_flag equal to 1 that is not a PON-nested SEI message, there shall not be an associated equirectangular projection SEI message in the same CLVS that is a PON-nested SEI message.

When a generalized cubemap project SEI message is present with gcmp_persistence_flag equal to 1 that is not a PON-nested SEI message, there shall not be an associated generalized cubemap project SEI message in the same CLVS that is a PON-nested SEI message.

When a sphere rotation SEI message is present with sphere_rotation_persistence_flag equal to 1 that is not a PON-nested SEI message, there shall not be an associated sphere rotation SEI message in the same CLVS that is a PON-nested SEI message.

When a region-wise packing SEI message is present with rwp_persistence_flag equal to 1 that is not a PON-nested SEI message, there shall not be an associated region-wise packing SEI message in the same CLVS that is a PON-nested SEI message.

When an omnidirectional viewport SEI message is present with omni_viewport_persistence_flag equal to 1 that is not a PON-nested SEI message, there shall not be an associated omnidirectional viewport SEI message in the same CLVS that is a PON-nested SEI message.

When a sample aspect ratio SEI message is present with sari_persistence_flag equal to 1 that is not a PON-nested SEI message, there shall not be an associated sample aspect ratio SEI message in the same CLVS that is a PON-nested SEI message.

When an annotated regions SEI message is present that is not a PON-nested SEI message, there shall not be an associated annotated regions SEI message in the same CLVS that is a PON-nested SEI message.

When an alpha channel information SEI message is present that is not a PON-nested SEI message, there shall not be an associated alpha channel information SEI message in the same CLVS that is a PON-nested SEI message.

When a display orientation SEI message is present that is not a PON-nested SEI message, there shall not be an associated display orientation SEI message in the same CLVS that is a PON-nested SEI message.

When a colour transform indication SEI message is present with colour_transform_persistence_flag equal to 1 that is not a PON-nested SEI message, there shall not be an associated colour transform indication SEI message in the same CLVS with colour_transform_cancel_flag equal to 1 or the same value of colour_transform_id that is a PON-nested SEI message.

The pon_num_po_ids_minus1 plus 1 specifies the number of the SEI processing order SEI messages SEI associated with this PON SEI message.

The pon_target_po_id[i] indicates the po_id of the i-th associated SEI processing order SEI message.

The pon_num_seis_minus1 plus 1 specifies the number of the PON-nested SEI messages that are included in this PON SEI message.

The pon_processing_order[i] specifies the position of the i-th processing-order-nested SEI message within the processing order defined by the associated SEI processing order SEI message. When i is greater than 0, pon_processing_order[i] shall be greater than or equal to pon_processing_order[i−1].

For each associated SEI processing order SEI message there shall be at least one value of i in the range of 0 to pon_num_seis_minus1, inclusive, in the PON SEI message for which the associated SEI processing order SEI message has some entry k for which all of the following are true:

The po_sei_processing_order[k] is equal to pon_processing_order[i]

The po_sei_payload_type[k] is equal to the payloadType value of the i-th PON-nested SEI message.

When po_sei_prefix_flag[k] is equal to 1, po_sei_prefix_data_bit[k][j] for j in the range of 0 to po_num_bits_in_prefix_indication_minus1[k], inclusive, contain the same content as the The po_num_bits_in_prefix_indication_minus1[k] plus 1 initial bits of the SEI message payload of the i-th PON-nested SEI message.

The i-th PON-nested SEI message should be applied as the k-th loop entry of the associated SEI processing order SEI message.

In the current design, SEI Processing Order (SPO) SEI message and Processing Order Nesting (PON) SEI message are tightly associated such that they may require the presence of the other one. The current semantics of po_sei_wrapping_flag[i] of SPO SEI message is shown below:

The po_sei_wrapping_flag[i] equal to 1 specifies that one or more processing order nesting SEI messages with both of the following constraints should be present:

The pon_target_po_id[j] with any value of j is equal to po_id.

There is a k-th loop entry in the processing order nesting SEI message such that the payloadType of the k-th nested SEI message is equal to po_sei_payload_type[i] and pon_processing_order[k] is equal to po_sei_processing_order[i].

When po_sei_wrapping_flag[i] is equal to 0, an SEI message with payloadType equal to po_sei_payload_type[i] (and, when po_sei_prefix_flag[i] equal to 1, prefix data that matches the values of po_sei_prefix_data_bit[i][j]) should be present outside of the processing order nesting SEI message.

NOTE 2—po_sei_wrapping_flag[i] equal to 1 enables SEI messages to be carried within the processing order nesting SEI message to prevent such SEI messages from being incorrectly interpreted by decoders that do not process the SPO SEI message. Thus, po_sei_wrapping_flag[i] equal to 1 is intended to be used when po_sei_wrapping_flag[i] equal to 0 can lead to unintended results being produced by such decoders.

In authors' assertion, the above semantics may be interpreted as if it calls for the presence of one or more Processing Order Nesting (PON) SEI message(s) that contains that i-th SEI message when the value of that syntax element is equal to 1. We believe this is not a good design because if this is design then it will have problem in the case of PON SEI message being remove from the bitstream. To satisfy the above semantics, then in the case of PON SEI message removal from a bitstream, it must also be ensure that all target SPO SEI message associated with that removed PON SEI message be updated.

Similar issue applies, too, for the case when the value of po_sei_wrapping_flag[i] is equal to 0. The current semantics may be interpreted as it calls for the presence of the i-th SEI message in the bitstream. We believe, the intent is that this processing order for that i-th SEI message is applicable/in-effect only when that SEI is present, however, that SEI message itself is not guaranteed to be present.

The following inventions provide solutions to the problem; described above. Each invention item may be applicable individually or in combinations.

The embodiment is summarized as follows. The operations and configurations described below form an embodiment together with the operations and configurations described above, unless they are inconsistent with the operations and configurations described above, and the operations and configurations described below do not form a separate embodiment that is distinct from the operations and configurations described above.

Modify semantics of po_sei_wrapping_flag[i] to express where the SEI that can be considered as the i-th SEI in the processing chain specified by the SPO SEI message is present; that is, when it is equal to 1, such SEI is present in PON SEI message, otherwise, such SEI is not present in PON SEI message.

Note that even when the value of po_sei_wrapping_flag[i] is equal to 1, it is possible that an SEI that with payloadType equal to po_sei_payload_type[i] and if po_sei_prefix_flag[i] equal to 1, prefix data that matches the values of po_sei_prefix_data_bit[i][j], is present in the CVS without being in a PON SEI message. However, such SEI shall not be considered as the i-th SEI message in the processing chain specified by the SPO SEI message.

For bitstream conformance checking, decoder shall not issue an error when it cannot find SEI message that is marked as wrapped in an SPO message (i.e., the value of po_sei_wrapping_flag[i] is equal to 1) in the current CVS.

Modify the semantics of syntax element po_sei_wrapping_flag[i] to be more flexible that allow the i-th SEI to be not presence in the bitstream. However, when it is present, it is still required to be present only in one or more PON SEI message(s).

In other words, the value of the syntax element po_sei_wrapping_flag[i] has the following means:

When it is equal to 1, it means that if the i-th SEI message is present in the CVS, it shall be present within a PON SEI message.

When it is equal to 0, it means that if the i-th SEI message is present in the CVS, it shall not be present within a PON SEI message.

The embodiments are described in detail below. One embodiment provides an explanation of the summary described above.

According to one embodiment, the po_sei_wrapping_flag[i] equal to 1 specifies that any SEI message that is not included in a PON SEI message is not applied as the i-th SEI message type in the processing chain specified by this SPO SEI message. po_sei_wrapping_flag[i] equal to 0 specifies that any SEI message that is included in a PON SEI message is not applied as the i-th SEI message type in the processing chain specified by this SPO SEI message.

The po_sei_wrapping_flag[i] equal to 1 enables SEI messages to be carried within the processing order nesting SEI message to prevent such SEI messages from being incorrectly interpreted by decoders that do not process the SPO SEI message. Thus, po_sei_wrapping_flag[i] equal to 1 is intended to be used when po_sei_wrapping_flag[i] equal to 0 can lead to unintended results being produced by such decoders.

According to one embodiment, the po_sei_wrapping_flag[i] equal to 1 specifies the SEI that applies as the i-th SEI message in the processing chain specified in this SPO SEI message is SEI that is included in a PON SEI message for which all the the following apply:

The pon_target_po_id[j] with any value of j is equal to po_id.

There is a k-th loop entry in the processing order nesting SEI message such that the payloadType of the k-th nested SEI message is equal to po_sei_payload_type[i] and pon_processing_order[k] is equal to po_sei_processing_order[i].

The po_sei_wrapping_flag[i] is equal to 0 the SEI that applies as the i-th SEI message in the processing chain specified in this SPO SEI message is SEI that is not included in a PON SEI message for which all the following apply:

The payloadType of the SEI message is equal po_sei_payload_type[i].

If po_sei_prefix_flag[i] equal to 1, prefix data of the SEI message matches the values of po_sei_prefix_data_bit[i][j]).

The po_sei_wrapping_flag[i] equal to 1 enables SEI messages to be carried within the processing order nesting SEI message to prevent such SEI messages from being incorrectly interpreted by decoders that do not process the SPO SEI message. Thus, po_sei_wrapping_flag[i] equal to 1 is intended to be used when po_sei_wrapping_flag[i] equal to 0 can lead to unintended results being produced by such decoders.

According to one embodiment, the po_sei_wrapping_flag[i] equal to 1 specifies that the i-th SEI message, if present in the CVS, shall be included in one or more processing order nesting SEI messages that satisfy both of the following constraints:

The pon_target_po_id[j] with any value of j is equal to po_id.

There is a k-th loop entry in the processing order nesting SEI message such that the payloadType of the k-th nested SEI message is equal to po_sei_payload_type[i] and pon_processing_order[k] is equal to po_sei_processing_order[i].

When po_sei_wrapping_flag[i] is equal to 0, an SEI message with payloadType equal to po_sei_payload_type[i] (and, when po_sei_prefix_flag[i] equal to 1, prefix data that matches the values of po_sei_prefix_data_bit[i][j]), if present, shall should be present outside of the processing order nesting SEI message.

The po_sei_wrapping_flag[i] equal to 1 enables SEI messages to be carried within the processing order nesting SEI message to prevent such SEI messages from being incorrectly interpreted by decoders that do not process the SPO SEI message. Thus, po_sei_wrapping_flag[i] equal to 1 is intended to be used when po_sei_wrapping_flag[i] equal to 0 can lead to unintended results being produced by such decoders.

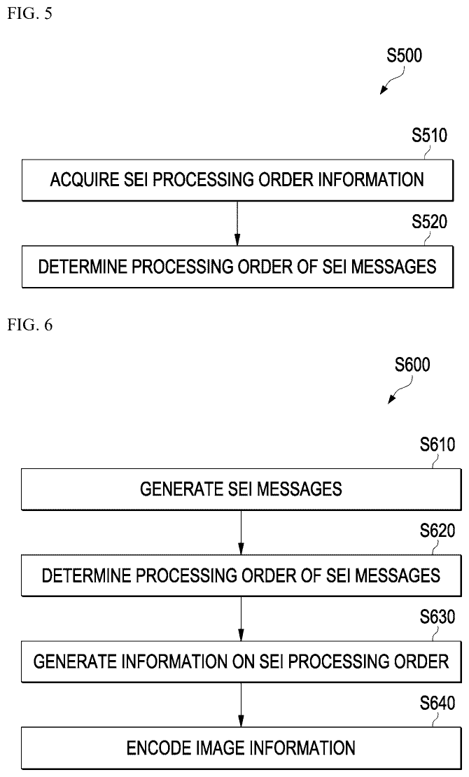

FIG. 5 is a flowchart illustrating a method of decoding image information according to an embodiment of the present disclosure.

Terms and names (e.g., names of syntax elements, names of variables, etc.) shown in FIG. 5 are mere examples, and the technical features of the present disclosure are not limited by the terms or the like shown in FIG. 5. For example, image information described in FIG. 5 may include various kinds of information according to embodiments described in the present disclosure and may include information shown in at least one of the above-described tables.

A decoding method 500 may include operations to be described below. The operations to be described below are not essential elements of the decoding method according to the embodiment, and at least some of the operations to be described below may be omitted. In addition, the operations to be described below are not sufficient elements of the decoding method according to the embodiment, and the above-described operations may be added. Further, the operations to be described below are integrated with the above-described operations into the embodiment unless they contradict the above-described operations, and do not constitute an embodiment separately from the above-described operations.

The decoding method 500 may be executed by a decoding apparatus including a memory and a processor electrically connected to the memory, and may be executed by, for example, the processor.

The decoding apparatus may acquire supplemental enhancement information (SEI) processing order information (510).

As an example, the processor of the decoding apparatus may acquire image information including a plurality of SEI messages, an SEI processing order message indicating a processing order of the plurality of SEI messages based on payload types of the SEI messages, and a processing order nesting message including nested SEI messages belonging to a processing chain designated by the SEI processing order message. The processing chain may be a list of types of SEI messages identified by the SEI processing order message.

The plurality of SEI messages may be SEI messages with various payload types. For example, the plurality of SEI messages may include SEI messages with different payload types and/or SEI messages with the same payload type.

The SEI processing order message may include information on a processing order of a group of types of SEI messages that may exist in a coded video sequence (CVS) or coded layer video sequence (CLVS).

The SEI processing order message may have various names, such as SEI processing order SEI message, SEI processing order (SPO) SEI message, etc., and there is no limitation on the name.

The SEI processing order message may have various forms. For example, the SEI processing order message may be a syntax element or a syntax structure including one or more syntax elements. In addition, the SEI processing order message may be a raw byte sequence payload (RBSP) including one or more syntax elements or one or more syntax structures. For example, the SEI processing order message may be referred to as sei_processing_order( ), etc., but is not limited thereto.

The SEI processing order message may include identification information, wrapping flag information, payload type information, prefix flag information, and/or processing order information.

The identification information may include an identifier for identifying the SEI processing order message from other SEI processing order messages (e.g., an identification number, an identification character, an identification mark, etc.).

The identification may have various forms and may be referred to by various names. For example, the identification information may be a syntax element or a syntax structure including one or more syntax elements. As an example, the identification information which is a syntax element may be referred to as po_id, etc., but is not limited thereto.

The wrapping flag information may indicate whether an SEI message belonging to the processing chain designated by the SEI processing order message is included in the processing order nesting message.

For example, a wrapping flag information value of 1 may represent that the SEI message belonging to the processing chain designated by the SEI processing order message is included in the processing order nesting message, that is, the processing order nesting message includes the SEI message belonging to the processing chain designated by the SEI processing order message.

Also, a wrapping flag information value of 0 may represent that the SEI message belonging to the processing chain designated by the SEI processing order message is not included in the processing order nesting message, that is, the processing order nesting message does not include the SEI message belonging to the processing chain designated by the SEI processing order message.

However, the present disclosure is not limited thereto, and alternatively, what is specified by the wrapping flag information value of 1 may be exchanged with what is specified by the wrapping flag information value of 0.

In addition, when a wrapping flag information value is 1, target identification information of the processing order nesting message may be the same as identification information of the SEI processing order message, a payload type of nested SEI messages may be the same as a payload type designated by the SEI processing order message, and a processing order of the nested SEI messages may be the same as a processing order designated by the SEI processing order message.

The wrapping flag information may be referred to by various names. For example, the wrapping flag information may be a syntax element or a syntax structure including one or more syntax elements. As an example, the wrapping flag information which is a syntax element may be a wrapping flag of one bit or a wrapping indicator of two or more bits. The wrapping flag information which is a syntax element may be referred to as po_sei_wrapping_flag[i], etc., but is not limited thereto.

The payload type information may indicate types of SEI messages. For example, the payload type information may specify payloadType values of the SEI messages.

The payload type information may have various forms and may be referred to by various names. For example, the payload type information may be a syntax element or a syntax structure including one or more syntax elements. As an example, the payload type information may be referred to as po_sei_payload_type[i], etc., but is not limited thereto.

The prefix flag information may indicate whether a corresponding SEI message corresponds to prefix information. Here, the prefix information may include bit count information po_num_bits_in_prefix_indication_minus1[i] of a prefix indication and prefix data bits po_sei_prefix_data_bit[i][j]. For example, a prefix flag information value of 1 may specify that the corresponding SEI message corresponds to prefix information. Also, a prefix flag information value of 0 may specify that the corresponding SEI message does not correspond to any prefix information. However, the present disclosure is not limited thereto, and alternatively, what is specified by the prefix flag information value of 1 may be exchanged with what is specified by the prefix flag information value of 0.

The prefix flag information may have various forms and may be referred to by various names. For example, the prefix flag information may be a syntax element or a syntax structure including one or more syntax elements. As an example, the prefix flag information which is a syntax element may be a prefix flag of one bit or a prefix indicator of two or more bits. The prefix flag information which is a syntax element may be referred to as po_sei_prefix_flag[i], etc., but is not limited thereto.

The processing order information may indicate a processing turn of a corresponding type of SEI message. With a lower value of processing order information for a specific type, the specific type of SEI message may be processed earlier. In other words, when a value of processing order information for a first type is smaller than a value of processing order information for a second type, the first type of SEI message may be processed before the second type of SEI message.

The processing order information may have various forms and may be referred to by various names. For example, the processing order information may be a syntax element or a syntax structure including one or more syntax elements. As an example, the processing order information may be referred to as po_sei_processing_order[i], etc., but is not limited thereto.

The processing order nesting message may be associated with a specific SEI processing order message and may include SEI messages that work as a part of a processing chain identified from the associated SEI processing order message (hereinafter “nested SEI messages”) and information on a processing order of the types of SEI messages.

The processing order nesting message may be referred to by various names such as processing order nesting SEI message, processing order nesting (PON) SEI message, etc., and there is no limitation on the name when the processing order nesting message includes nested SEI messages and information on a processing order of the types of nested SEI messages.

The nested SEI messages do not depend on any SEI message not included in the processing order nesting message. Specifically, the semantics and effect of an SEI message that is not a PON SEI message do not affect any PON SEI message.

The processing order nesting message may be referred to by various names such as processing order nesting SEI message, PON SEI message, etc., and there is no limitation on the name.

The processing order nesting message may have various forms and may be referred to by various names. For example, the processing order nesting message may be a syntax element or a syntax structure including one or more syntax elements. In addition, the processing order nesting message may be an RBSP including one or more syntax elements or one or more syntax structures. For example, the processing order nesting message may be referred to as processing_order_nesting( ), etc., but is not limited thereto.

The processing order nesting message may include target identification information, nesting order information, and/or nested SEI messages.

The target identification information may include an identifier (e.g., an identification number, an identification character, an identification mark, and/or the like) for identifying the SEI processing order message associated with the processing order nesting message.

The target identification information may have various forms and may be referred to by various names. For example, the target identification information may be a syntax element or a syntax structure including one or more syntax elements. For example, the target identification information which is a syntax element may be referred to as pon_target_po_id[i], etc., but is not limited thereto.

The nesting order information may specify positions of the nested SEI messages in a processing order defined by the SEI processing order message associated with the processing order nesting message.

The nesting order information may have various forms and may be referred to by various names. For example, the nesting order information may be a syntax element or a syntax structure including one or more syntax elements. For example, the nesting order information may be referred to as pon_processing_order[i], etc., but is not limited thereto.

The nested SEI messages indicate SEI messages included in the processing order nesting message.

The decoding apparatus may determine a processing order of SEI messages (520).

As an example, the processor of the decoding apparatus may determine a processing order of SEI messages on the basis of the SEI processing order message. The processor may determine a processing order for the group of the types of SEI messages on the basis of the processing order information included in the SEI processing order message. In addition, the processor may process SEI messages in the determined processing order.

In this way, the SEI processing order message may be associated with the processing order nesting message.

Here, SEI messages including the SEI processing order message and the processing order nesting message are optional. An SEI message may be selectively transmitted from the encoding apparatus, or SEI messages may be selectively transmitted from a network entity that transmits image information. In other words, SEI messages may be dropped by the encoding apparatus, a transmission apparatus, or a network entity.

For example, an SEI message belonging to the processing chain designated by the SEI processing order message may be dropped by the encoding apparatus, a transmission apparatus, or a network entity and may not be included in the image information acquired by the decoding apparatus.

An SEI message belonging to the processing chain designated by the SEI processing order message may be allowed not to be included the image information acquired by the decoding apparatus. In other words, an SEI message belonging to the processing chain designated by the SEI processing order message may or may not exist in the image information.

For example, SEI messages in the processing chain designated by the SEI processing order message may include an SEI message existing in the image information or an SEI message not existing in the image information. Even when SEI messages in the processing chain designated by the SEI processing order message include an SEI message not existing in the image information, the processor of the decoding apparatus may continue processing the SEI processing order message without outputting an error or stopping processing the SEI processing order message.

The payload type information of the SEI processing order message may include type information of SEI messages existing in the image information or type information of SEI messages not existing in the image information. Even when the payload type information of the SEI processing order message includes type information of SEI messages not existing in the image information, the processor of the decoding apparatus may continue processing the SEI processing order message without outputting an error or stopping processing the SEI processing order message.

In particular, when an SEI message belonging to the processing chain designated by the SEI processing order message exists in the image information, the wrapping flag information may indicate whether the SEI message is included in the processing order nesting message.

For example, when an SEI message belonging to the processing chain designated by the SEI processing order message exists in the image information, a wrapping flag information value of 1 may represent that the SEI message is included in the processing order nesting message. In other words, when the wrapping flag information value is 1, an SEI message belonging to the processing chain designated by the SEI processing order message is allowed not to exist in the image information, but when the SEI message exists in the image information, the SEI message is included in the processing order nesting message.

Also, when an SEI message belonging to the processing chain designated by the SEI processing order message exists in the image information, a wrapping flag information value of 0 may represent that the SEI message is not included in the processing order nesting message. In other words, when the wrapping flag information value is 0, an SEI message belonging to the processing chain designated by the SEI processing order message is allowed not to exist in the image information, but when the SEI message exists in the image information, the SEI message is not included in the processing order nesting message.

As described above, an SEI message belonging to a processing chain designated by an SEI processing order message is allowed not to be included in image information acquired by a decoding apparatus, and flexibility is given to processing of an SEI processing order message and/or a processing order nesting message. Accordingly, errors or operation interruptions are reduced during coding operations, leading to improvements in coding efficiency and coding rates.

FIG. 6 is a flowchart illustrating a method of encoding image information according to an embodiment of the present disclosure.

Terms and names (e.g., names of syntax elements, names of variables, etc.) shown in FIG. 6 are mere examples, and the technical features of the present disclosure are not limited by the terms or the like shown in FIG. 6. For example, image information described in FIG. 6 may include various kinds of information according to embodiments described in the present disclosure and may include information shown in at least one of the above-described tables.

An encoding method 600 may include operations to be described below. The operations to be described below are not essential elements of the encoding method according to the embodiment, and at least some of the operations to be described below may be omitted. In addition, the operations to be described below are not sufficient elements of the encoding method according to the embodiment, and the above-described operations may be added. Further, the operations to be described below are integrated with the above-described operations into the embodiment unless they contradict the above-described operations, and do not constitute an embodiment separately from the above-described operations.

The encoding apparatus may generate SEI messages (610).

For example, the processor of the encoding apparatus may generate a plurality of SEI messages. The plurality of SEI messages may be SEI messages with various payload types. As an example, the plurality of SEI messages may include SEI messages with different payload types and/or SEI messages with the same payload type.

The encoding apparatus may determine a processing order of the SEI messages (620).

For example, the processor of the encoding apparatus may determine a processing order of a group of types of SEI messages.

The encoding apparatus may generate information on an SEI processing order (630).

For example, the processor of the encoding apparatus may generate the information on the SEI processing order on the basis of the processing order of a group of types of SEI messages. Here, the information on the SEI processing order may include an SEI processing order message indicating a processing order of a plurality of SEI messages based on payload types of the SEI messages and nested SEI messages belonging to a processing chain designated by the SEI processing order message.

The SEI processing order message may include information on a processing order of a group of types of SEI messages that may exist in a CVS or CLVS.

As described above in FIG. 5, the SEI processing order message may have various forms and various names.

As described above in FIG. 5, the SEI processing order message may include identification information, wrapping flag information, payload type information, prefix flag information, and/or processing order information.

The identification information may be the same as the identification information described above in FIG. 5, and description thereof will be replaced with the description of the identification information of FIG. 5.

The wrapping flag information may indicate whether an SEI message belonging to the processing chain designated by the SEI processing order message is included in a processing order nesting message.

For example, a wrapping flag information value of 1 may represent that the SEI message belonging to the processing chain designated by the SEI processing order message is included in the processing order nesting message, that is, the processing order nesting message includes the SEI message belonging to the processing chain designated by the SEI processing order message.

Also, a wrapping flag information value of 0 may represent that the SEI message belonging to the processing chain designated by the SEI processing order message is not included in the processing order nesting message, that is, the processing order nesting message does not include the SEI message belonging to the processing chain designated by the SEI processing order message.

However, the present disclosure is not limited thereto, and alternatively, what is specified by the wrapping flag information value of 1 may be exchanged with what is specified by the wrapping flag information value of 0.

The wrapping flag information may have various forms and may be referred to by various names. For example, the wrapping flag information may be a syntax element or a syntax structure including one or more syntax elements. As an example, the wrapping flag information which is a syntax element may be a wrapping flag of one bit or a wrapping indicator of two or more bits. The wrapping flag information which is a syntax element may be referred to as po_sei_wrapping_flag[i], etc., but is not limited thereto.

In addition, when a wrapping flag information value is 1, target identification information of the processing order nesting message may be the same as identification information of the SEI processing order message, a payload type of nested SEI messages may be the same as a payload type designated by the SEI processing order message, and a processing order of the nested SEI messages may be the same as a processing order designated by the SEI processing order message.

The payload type information may be the same as the payload type information described above in FIG. 5, and description thereof will be replaced with the description of the payload type information of FIG. 5.

The prefix flag information may be the same as the prefix flag information described above in FIG. 5, and description thereof will be replaced with the description of the prefix flag information of FIG. 5.

The processing order information may be the same as the processing order information described above in FIG. 5, and description thereof will be replaced with the description of the processing order information of FIG. 5.

The processing order nesting message may be associated with a specific SEI processing order message and may include SEI messages that work as a part of a processing chain identified from the specific SEI processing order message (hereinafter “nested SEI messages”) and information on a processing order of the types of SEI messages.

As described above in FIG. 5, the processing order nesting message may have various forms and may be referred to by various names.

As described above in FIG. 5, the processing order nesting message may include target identification information, nesting order information, and/or nested SEI messages.

The target identification information may be the same as the target identification information described above in FIG. 5, and description thereof will be replaced with the description of the target identification information of FIG. 5.

The nesting order information may be the same as the nesting order information described above in FIG. 5, and description thereof will be replaced with the description of the nesting order information of FIG. 5.

The nested SEI messages indicate SEI messages included in the processing order nesting message.

The encoding apparatus may encode image information including SEI messages, the SEI processing order message, and/or the processing order nesting message (640).

For example, image information including SEI messages, the SEI processing order message, and/or the processing order nesting message of the encoding apparatus may be encoded.

In this way, the SEI processing order message may be associated with the processing order nesting message.

Here, SEI messages including the SEI processing order message and the processing order nesting message are optional. An SEI message may be selectively transmitted from the encoding apparatus. In other words, SEI messages may be dropped by the encoding apparatus.

For example, an SEI message belonging to the processing chain designated by the SEI processing order message may be dropped by the encoding apparatus.

An SEI message belonging to the processing chain designated by the SEI processing order message may be allowed not to be included the image information encoded by the encoding apparatus. In other words, an SEI message belonging to the processing chain designated by the SEI processing order message may or may not exist in the image information.

For example, SEI messages in the processing chain designated by the SEI processing order message may include an SEI message existing in the image information or an SEI message not existing in the image information. Even when SEI messages in the processing chain designated by the SEI processing order message include an SEI message not existing in the image information, the processor of the encoding apparatus may continue encoding the SEI processing order message without outputting an error or stopping encoding the SEI processing order message.

The payload type information of the SEI processing order message may include type information of SEI messages existing in the image information or type information of SEI messages not existing in the image information. Even when the payload type information of the SEI processing order message includes type information of SEI messages not existing in the image information, the processor of the encoding apparatus may continue encoding the SEI processing order message without outputting an error or stopping encoding the SEI processing order message.

In particular, when an SEI message belonging to the processing chain designated by the SEI processing order message exists in the image information, the wrapping flag information may indicate whether the SEI message is included in the processing order nesting message.

For example, when an SEI message belonging to the processing chain designated by the SEI processing order message exists in the image information, a wrapping flag information value of 1 may represent that the SEI message is included in the processing order nesting message. In other words, when the wrapping flag information value is 1, an SEI message belonging to the processing chain designated by the SEI processing order message is allowed not to exist in the image information, but when the SEI message exists in the image information, the SEI message is included in the processing order nesting message.

Also, when an SEI message belonging to the processing chain designated by the SEI processing order message exists in the image information, a wrapping flag information value of 0 may represent that the SEI message is not included in the processing order nesting message. In other words, when the wrapping flag information value is 0, an SEI message belonging to the processing chain designated by the SEI processing order message is allowed not to exist in the image information, but when the SEI message exists in the image information, the SEI message is not included in the processing order nesting message.

As described above, an SEI message belonging to a processing chain designated by an SEI processing order message is allowed not to be included in image information coded by a encoding apparatus, and flexibility is given to encoding of an SEI processing order message and/or a processing order nesting message. Accordingly, errors or operation interruptions are reduced during coding operations, leading to improvements in coding efficiency and coding rates.

A bitstream is generated on the basis of the image information encoded according to the above-described encoding method 600, and the bitstream may be stored in a computer-readable storage medium

Also, a bitstream is generated on the basis of the image information encoded according to the above-described encoding method 600, and the bitstream may be transmitted through a transmitter and/or a transmission medium.

Terms or names (e.g., names of syntax elements, names of variables, etc.) to be described below are mere examples, and the technical features of the present disclosure are not limited by the terms or the like. For example, image information to be described below may include various kinds of information according to embodiments described in the present disclosure and may include information shown in at least one of the above-described tables.

Operations to be described below are not essential elements of an embodiment, and at least some of the operations to be described below may be omitted. In addition, the operations to be described below are not sufficient elements of the embodiment, and the above-described operations may be added. Further, the operations to be described below are integrated with the above-described operations into the embodiment unless they contradict the above-described operations, and do not constitute an embodiment separately from the above-described operations.

As described in FIGS. 5 and 6, image information may include a plurality of SEI messages, an SEI processing order message, and/or a processing order nesting message. The SEI processing order message may include identification information, wrapping flag information, payload type information, prefix flag information, and/or processing order information. In addition, the processing order nesting message may include target identification information, nesting order information, and/or nested SEI messages.

Here, SEI messages including the SEI processing order message and the processing order nesting message may be dropped by the encoding apparatus, a transmission apparatus, or a network entity and may not be included in the image information acquired by the decoding apparatus. For example, an SEI message belonging to the processing chain designated by the SEI processing order message may be dropped by the encoding apparatus, a transmission apparatus, or a network entity. To ensure flexibility and stability of operations of the encoding apparatus and decoding apparatus, an SEI message including the SEI processing order message and the associated processing order nesting message may be allowed not to be included in image information coded by the encoding apparatus or image information acquired by the decoding apparatus.

For example, a first SEI processing order message, a second SEI processing order message, a first SEI message, a second SEI message, a first processing order nesting message, and a second processing order nesting message may be generated.

Payload type information of the first SEI message A1 may have a value of 120, and payload type information of the second SEI message A2 may have a value of 220.

Information included in the first SEI processing order message and second SEI processing order message may be as shown in table 3 and table 4, respectively.

TABLE 3
First SEI processing order message (identification = 00)

| | Wrapping flag | Payload type | Processing order |
|---|---|---|---|
| i | information | information | information |
| 0 | 1 | 100 | x1 |
| 1 | 0 | 120 | y1 |
| 2 | 1 | 150 | z1 |

TABLE 4
Second SEI processing order message
(identification information = 10)

| | Wrapping flag | Payload type | Processing order |
|---|---|---|---|
| i | information | information | information |
| 0 | 1 | 200 | x2 |
| 1 | 0 | 220 | y2 |
| 2 | 1 | 250 | z2 |

For example, as shown in tables 3 and 4, the first SEI processing order message having identification information of 00 may include turn information of an SEI message having a wrapping flag information value of 1 and a payload type information value of 100, turn information of an SEI message having a wrapping flag information value of 0 and a payload type information value of 120, and turn information of an SEI message having a wrapping flag information value of 1 and a payload type information value of 150.

The second SEI processing order message having identification information of 10 may include turn information of an SEI message having a wrapping flag information value of 1 and a payload type information value of 200, turn information of an SEI message having a wrapping flag information value of 0 and a payload type information value of 220, and turn information of an SEI message having a wrapping flag information value of 1 and a payload type information value of 250.

Information included in the first processing order nesting message and the second processing order nesting message may be as shown in table 5 and table 6, respectively.

TABLE 5
First processing order nesting message (target information = 00)

| | | Payload type | Processing order |
|---|---|---|---|
| i | SEI message | information | information |
| 0 | B1 | 100 | x1 |
| 1 | C1 | 150 | z1 |

TABLE 6
Second processing order nesting message
(target identification information = 10)

| | | Payload type | Processing order |
|---|---|---|---|
| i | SEI message | information | information |
| 0 | B2 | 200 | x2 |
| 1 | C2 | 250 | z2 |

For example, as shown in tables 5 and 6, the first processing order nesting message may have target identification information of 00 and include a nested SEI message B1 having a payload type information value of 100 and a nested SEI message C1 having a payload type information value of 150.

The second processing order nesting message may have target identification information of 10 and include a nested SEI message B2 having a payload type information value of 200 and a nested SEI message C2 having a payload type information value of 250. Encoded image information may be transmitted to the decoding apparatus via a network.

For example, the second processing order nesting message may be dropped while being coded by the encoding apparatus or transmitted via the network. The decoding apparatus may acquire image information including the first SEI processing order message, the second SEI processing order message, the first SEI message, the second SEI message, and the first processing order nesting message.

The first SEI processing order message may be encoded or processed. While the first SEI processing order message is encoded or processed, it may be determined whether constraints on SEI processing order messages are satisfied. For example, with regard to wrapping flag information, it may be determined whether constraints on whether an SEI message working as an ith SEI message in a processing chain designated by the first SEI processing order message is included in a processing order nesting message are satisfied.

For example, it may be determined whether constraints related to the first SEI processing order message are satisfied in accordance with wrapping flag information and payload type information. Based on the first SEI processing order message having a first wrapping flag information value of 1 and a payload type information value of 100, an SEI message working as a first SEI message in the processing chain may be the nested SEI message B1. Based on the first SEI processing order message having a second wrapping flag information value of 0 and a payload type information value of 120, an SEI message working as a second SEI message in the processing chain may be the first SEI message A1 not included in the processing order nesting message. Based on the first SEI processing order message having a third wrapping flag information value of 1 and a payload type information value of 150, an SEI message working as a third SEI message in the processing chain may be the nested SEI message C1.

In this way, it is determined that the constraints related to the first SEI processing order message are satisfied, and the nested SEI message B1, the first SEI message A1, and the nested SEI message C1 may be encoded or processed.

The second SEI processing order message may be encoded or processed. While the second SEI processing order message is encoded or processed, it may be determined whether the constraints on SEI processing order messages are satisfied. For example, with regard to wrapping flag information, it may be determined whether constraints on whether an SEI message working as an ith SEI message in a processing chain designated by the second SEI processing order message is included in a processing order nesting message are satisfied.

For example, it may be determined whether constraints related to the second SEI processing order message are satisfied in accordance with wrapping flag information and payload type information. Based on the second SEI processing order message having a first wrapping flag information value of 1 and a payload type information value of 200, an SEI message working as a first SEI message in the processing chain may be searched for in the processing order nesting message. Here, the nested SEI message B2 having a payload type information value of 200 does not exist in the image information.

Even when the nested SEI message B2 does not exist in the image information, it is determined that the constraints related to the second SEI processing order message are satisfied, and the encoding apparatus or decoding apparatus can continue encoding or processing SEI messages without outputting an error or stopping processing the SEI messages. In other words, it is possible to continuously encode or process the second SEI processing order message.

Based on the second SEI processing order message having a second wrapping flag information value of 0 and a payload type information value of 220, an SEI message working as a second SEI message in the processing chain may be the second SEI message A2 not included in the processing order nesting message.

Based on the second SEI processing order message having a third wrapping flag information value of 1 and a payload type information value of 250, an SEI message working as a third SEI message in the processing chain may be searched for in the processing order nesting message. Here, the nested SEI message C2 having a payload type information value of 250 does not exist in the image information.

Even when the nested SEI message C2 does not exist in the image information, it is determined that the constraints related to the second SEI processing order message are satisfied, and the encoding apparatus or decoding apparatus can continue encoding or processing SEI messages without outputting an error or stopping processing the SEI messages. In other words, it is possible to continuously encode or process the second SEI processing order message.

As a result, it is determined that the constraints related to the SEI processing order message are satisfied, and the second SEI message A2 not included in the second processing order nesting message may be encoded or processed.

The SEI processing order message may include not only payload type information of nested SEI messages included in the image information but also payload type information of nested SEI messages not included in the image information. Accordingly, type information of SEI messages constituting the processing chain designated by the SEI processing order message may also include not only payload type information of the nested SEI messages included in the image information but also payload type information of the nested SEI messages not included in the image information.

Also, for example, the second SEI message A2 may be dropped while being coded by the encoding apparatus or transmitted via the network. The decoding apparatus may acquire image information including the first SEI processing order message, the second SEI processing order message, the first SEI message, the first processing order nesting message, and the second processing order nesting message.

The second SEI processing order message may be encoded or processed. While the second SEI processing order message is encoded or processed, it may be determined whether constraints on SEI processing order messages are satisfied. For example, with regard to wrapping flag information, it may be determined whether constraints on whether an SEI message working as an ith SEI message in a processing chain designated by the second SEI processing order message is included in a processing order nesting message are satisfied.

For example, it may be determined whether constraints related to the second SEI processing order message are satisfied in accordance with wrapping flag information and payload type information. Based on the second SEI processing order message having a first wrapping flag information value of 1 and a payload type information value of 200, an SEI message working as a first SEI message in the processing chain may be the nested SEI message B2.

Based on the second SEI processing order message having a second wrapping flag information value of 0 and a payload type information value of 220, an SEI message working as the second SEI message in the processing chain may be searched for outside the processing order nesting message. Here, the second SEI message A2 having a payload type information value of 220 does not exist in the image information.

Even when the second SEI message A2 does not exist in the image information, it is determined that the constraints related to the second SEI processing order message are satisfied, and the encoding apparatus or decoding apparatus can continue encoding or processing SEI messages without outputting an error or stopping processing the SEI messages. In other words, it is possible to continuously encode or process the second SEI processing order message.

Based on the second SEI processing order message having a third wrapping flag information value of 1 and a payload type information value of 250, an SEI message working as a third SEI message in the processing chain may be the nested SEI message C2 having a payload type information value of 250.

As a result, it is determined that the constraints related to the SEI processing order message are satisfied, and the nested SEI message B2 and the nested SEI message C2 may be encoded or processed.

The SEI processing order message may include not only payload type information of SEI messages that are not nested SEI messages included in the image information, but also payload type information of SEI messages that are not nested SEI messages not included in the image information. Accordingly, type information of SEI messages that are not SEI messages constituting the processing chain designated by the SEI processing order message may also include not only payload type information of the nested SEI messages included in the image information but also payload type information of the SEI messages that are not nested SEI messages not included in the image information.

According to the embodiment, flexibility is given to processing of an SEI processing order message and/or a processing order nesting message, and errors or operation interruptions are reduced during coding operations, leading to improvements in coding efficiency and coding rates.

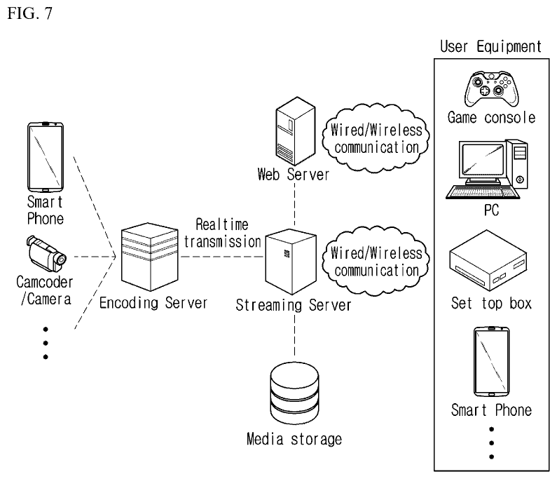

FIG. 7 is a diagram exemplifying a content streaming system to which an embodiment according to the present disclosure can be applied.

Referring to FIG. 7, the content streaming system to which the embodiment(s) of the present document is applied may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmit the bitstream to the streaming server. As another example, when the multimedia input devices such as smartphones, cameras, camcorders, etc. directly generate a bitstream, the encoding server may be omitted.

The bitstream may be generated by an encoding method or a bitstream generating method to which the embodiment(s) of the present document is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server delivers it to a streaming server, and the streaming server transmits multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (ex. smartwatches, smart glasses, head mounted displays), digital TVs, desktops computer, digital signage, and the like.

Each server in the content streaming system may be operated as a distributed server, in which case data received from each server may be distributed.

The scope of the present disclosure includes software or machine-executable instructions (e.g., an operating system, an application, firmware, a program, etc.) that cause operations according to various embodiments of the present disclosure to be executed on a device or a computer, and a non-transitory computer-readable medium having such software or instructions stored thereon and being executable on the device or the computer.

The embodiments of the present disclosure may be used to encode or decode an image.

What is claimed is:

1. A method for decoding image information, the method comprising:
obtaining the image information including supplemental enhancement information (SEI) messages, a SEI processing order message indicating a processing order for a group of types of the SEI messages, and a processing order nesting message including at least one nested SEI message in a processing chain specified by the SEI processing order message; and
deriving the processing order of the SEI messages based on the SEI processing order message,
wherein the SEI processing order message includes wrapping flag information indicating whether a SEI message in a processing chain specified by the SEI processing order message is included in the processing order nesting message.

2. The method of claim 1, wherein, based on a value of the wrapping flag information equal to 1, the SEI message in a processing chain specified by the SEI processing order message is included in the processing order nesting message, and
wherein, based on the value of the wrapping flag information equal to 0, the SEI message in a processing chain specified by the SEI processing order message is not included in the processing order nesting message.

3. The method of claim 1, wherein, based on a value of the wrapping flag information equal to 1, a target identifier of the processing order nesting message is equal to an identifier of the SEI processing order message, a payload type of the at least one nested SEI message is equal to a payload type specified by the SEI processing order message and a processing order of the at least one nested SEI message is equal to a processing order specified by the SEI processing order message.

4. The method of claim 1, wherein the SEI message in the processing chain specified by the SEI processing order message being not presence in the image information is allowed.

5. The method of claim 1, wherein the SEI message in the processing chain specified by the SEI processing order message includes at least one of a SEI message being presence in the image information or a SEI message being not presence in the image information.

6. The method of claim 1, wherein the SEI processing order message includes payload type information indicating a payload type of a SEI message, and
wherein the payload type information includes at least one of type information of a SEI message being presence in the image information or type information of a SEI message being not presence in the image information.

7. The method of claim 1, wherein, based on a value of the wrapping flag information equal to 1 and the SEI message in a processing chain specified by the SEI processing order message being presence in the image information, the SEI message in a processing chain specified by the SEI processing order message is included in the processing order nesting message, and
wherein, based on the value of the wrapping flag information equal to 0 and the SEI message in a processing chain specified by the SEI processing order message being presence in the image information, the SEI message in a processing chain specified by the SEI processing order message is not included in the processing order nesting message.

8. A method for encoding image information, the method comprising:
generating supplemental enhancement information (SEI) messages;
determining a processing order for a group of types of the SEI messages;
generating a SEI processing order message indicating the processing order based on the processing order;
generating a processing order nesting message including at least one nested SEI message in a processing chain specified by the SEI processing order message; and
encoding the image information including the SEI processing order message and the processing order nesting message,
wherein the SEI processing order message includes wrapping flag information indicating whether a SEI message in a processing chain specified by the SEI processing order message is included in the processing order nesting message.

9. The method of claim 8, wherein, based on the SEI message in a processing chain specified by the SEI processing order message being included in the processing order nesting message, a value of the wrapping flag information is equal to 1, and
wherein, based on the SEI message in a processing chain specified by the SEI processing order message being not included in the processing order nesting message, the value of the wrapping flag information is equal to 0.

10. The method of claim 8, wherein, based on a value of the wrapping flag information equal to 1, a target identifier of the processing order nesting message is equal to an identifier of the SEI processing order message, a payload type of the at least one nested SEI message is equal to a payload type specified by the SEI processing order message and a processing order of the at least one nested SEI message is equal to a processing order specified by the SEI processing order message.

11. The method of claim 8, wherein the SEI message in a processing chain specified by the SEI processing order message being not presence in the image information is allowed.

12. The method of claim 8, wherein the SEI message in the processing chain specified by the SEI processing order message includes at least one of a SEI message being presence in the image information or a SEI message being not presence in the image information.

13. The method of claim 8, wherein the SEI processing order message includes payload type information indicating a payload type of a SEI message, and
wherein the payload type information includes at least one of type information of a SEI message being presence in the image information or type information of a SEI message being not presence in the image information.

14. The method of claim 8, wherein, based on a value of the wrapping flag information equal to 1 and the SEI message in a processing chain specified by the SEI processing order message being presence in the image information, the SEI message in a processing chain specified by the SEI processing order message is included in the processing order nesting message, and
wherein, based on the value of the wrapping flag information equal to 0 and the SEI message in a processing chain specified by the SEI processing order message being presence in the image information, the SEI message in a processing chain specified by the SEI processing order message is not included in the processing order nesting message.

15. A method for transmitting data for image information, the method comprising:
generating a bitstream for the image information,
transmitting the data comprising the bitstream,
wherein the bitstream is generated based on generating supplemental enhancement information (SEI) messages, determining a processing order for a group of types of the SEI messages, generating a SEI processing order message indicating the processing order based on the processing order, generating a processing order nesting message including at least one nested SEI message in a processing chain specified by the SEI processing order message, and generating the bitstream for the image information including the SEI processing order message and the processing order nesting message; and
wherein the SEI processing order message includes wrapping flag information indicating whether a SEI message in a processing chain specified by the SEI processing order message is included in the processing order nesting message.
